(19) United States
(12) Patent Application Publication
(10) Pub. No.: US 2024/0350939 A1
(43) Pub. Date: Oct. 24, 2024

(54) AUGMENTED REALITY DISPLAY WITH ADJUSTABLE PARALLAX

(71) Applicant: Universal City Studios LLC, Universal City, CA (US)

(72) Inventors: Aaron Chandler Jeromin, Winter Garden, FL (US); Akiva Meir Krauthamer, Orlando, FL (US); Timothy Fitzgerald Garnier, Orlando, FL (US)

(21) Appl. No.: 18/619,131

(22) Filed: Mar. 27, 2024

Related U.S. Application Data
(60) Provisional application No. 63/461,392, filed on Apr. 24, 2023.

(51) Int. Cl. A63J 5/02

(52) U.S. Cl. CPC A63J 5/02

(57) ABSTRACT

A show effect system of an amusement park may include a sensor transmitting guest data, a display projecting virtual imagery, and a mirror deflecting the virtual imagery. The show effect system may also include an actuator coupled to the display and/or the mirror and a beam splitter with a partially transmissive and partially reflective viewing surface positioned between the viewing area and the mirror. The beam splitter may reflect light from the viewing area as reflected imagery back to the viewing area and enable transmission of the virtual imagery deflected off the mirror through the beam splitter to the viewing area as transmitted imagery. The show effect system may also include a controller communicatively coupled to the sensor, the actuator, and the display. The controller may instruct the actuator to adjust a position and/or orientation of the display, the mirror, or both based on the guest data.

### CROSS-REFERENCE TO RELATED APPLICATION

This application claims priority to and benefit of U.S. Provisional Application No. 63/461,392, entitled “AUGMENTED REALITY MIRROR WITH ADJUSTABLE PARALLAX,” filed Apr. 24, 2023, which is hereby incorporated by reference in its entirety for all purposes.

### BACKGROUND

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Throughout amusement parks and other entertainment venues, special effects can be used to help immerse guests in the experience of a ride or attraction. Immersive environments may include three-dimensional (3D) props and set pieces, robotic or mechanical elements, and/or display surfaces that present media. For example, amusement parks may provide an augmented reality (AR) experience for guests. The AR experience may include presenting virtual objects to guests, and the virtual objects may provide unique special effects to the guests. The special effects may enable the amusement part to provide creative methods of entertaining guests, such as by simulating real world elements in a convincing manner.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a show effect system of an amusement park may include one or more sensors configured to transmit guest data based on guest detection in a viewing area, a display configured to project one or more virtual images, and a mirror configured to deflect the one or more virtual images. The guest data may include location data indicative of a location of the guest. The show effect system may also include one or more actuators coupled with and configured to adjust positioning of the display and/or the mirror, a beam splitter comprising a partially transmissive and partially reflective viewing surface positioned between the viewing area and the mirror. The beam splitter may reflect light from the viewing area as reflected imagery back to the viewing area and enable transmission of the one or more virtual images deflected off the mirror through the beam splitter to the viewing area as transmitted imagery. The show effect system may also include one or more controllers communicatively coupled to the one or more sensors and communicatively coupled to the one or more actuators and/or the display, wherein the one or more controllers is configured to instruct the one or more actuators to adjust a position of the display, of the mirror, or both based on the location data.

In an embodiment, non-transitory computer-readable medium, comprising instructions that, when executed by one or more processors, are configured to cause the one or more processors to perform operations including determine a position of a guest relative to a show effect system of an amusement park attraction system and instructing one or more actuators of the show effect system to move the display, the mirror, or both to adjust projection of one or more virtual images onto the mirror and to adjust the second location of the transmitted element based on the position of the guest. The show effect system may include a beam splitter configured to reflect imagery of the guest as a reflected element at a first location. The show effect system may also include a mirror and a display configured to project the one or more virtual images through the beam splitter as a transmitted element onto a second location.

In an embodiment, an attraction system for an amusement park may include a viewing area for a guest, a beam splitter configured to reflect an appearance of the guest toward the viewing area, and a mirror positioned on an opposite side of the beam splitter from the viewing area. The attraction system may also include a display configured to project one or more virtual images onto the mirror such that the mirror deflects the one or more virtual images through the beam splitter and one or more actuators configured to move the mirror and/or the display to adjust an apparent depth of the one or more virtual images.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram of an embodiment of an attraction system of an amusement park, in accordance with an aspect of the present disclosure;

FIG. 2 is a side perspective view of the show effect system of FIG. 1, in accordance with an aspect of the present disclosure;

FIG. 3 is a side perspective view of an embodiment of the show effect system of FIG. 1, in accordance with an aspect of the present disclosure;

FIG. 4 is a flowchart of an embodiment of a method or a process for providing a show effect via the show effect system of FIG. 1, in accordance with an aspect of the present disclosure;

FIG. 5 is a flowchart of an embodiment of a method or a process for providing a show effect via the show effect system of FIG. 1, in accordance with an aspect of the present disclosure; and

FIG. 6 is a flowchart of an embodiment of a method or a process for providing a show effect via the show effect system of FIG. 1, in accordance with an aspect of the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As used herein, the terms “approximately,” “generally,” “substantially,” and so forth, are intended to convey that the property value being described may be within a relatively small range of the property value, as those of ordinary skill would understand. Mathematical terms, such as “parallel” and “perpendicular,” should not be rigidly interpreted in a strict mathematical sense, but should instead be interpreted as one of ordinary skill in the art would interpret such terms. For example, one of ordinary skill in the art would understand that two lines that are substantially parallel to each other are parallel to a substantial degree, but may have minor deviation from exactly parallel.

The present disclosure is directed to providing show effects for entertainment purposes. For example, present embodiments may be employed to entertain guests in an amusement park. The amusement park may include a variety of features, such as rides (e.g., a roller coaster), theatrical shows, set designs, performers, and/or decoration elements, to entertain guests. Show effects may be used to supplement or complement the features, such as to provide the guests with a more immersive and/or unique experience. For example, the show effects may be presented along with real world objects to provide an interactive experience for the guests.

An attraction system in accordance with present embodiments may include a show effect system configured to present virtual or simulated objects that supplement the appearance of real world objects. For example, the show effect system may track a guest's facial features and expressions to overlay virtual imagery or digital elements onto the real world objects (e.g., mapped to the guest's facial features and expressions), such as in real-time or near real-time. It may be desirable to provide the virtual imagery in a convincing manner, such as with proper dimensions with respect to guest attributes. Thus, the virtual imagery may appear as real world objects to provide a realistic show effect for guests.

Accordingly, embodiments of the present disclosure are directed to a show effect system that provides virtual imagery (e.g., one or more virtual images) having a realistic appearance, such as by providing the virtual imagery with a three-dimensional (3D) appearance and/or being positioned at a proper depth from a guest's perspective. In particular, the show effect system may include one or more sensors to detect a location of a guest relative to the show effect system and one or more attributes (e.g., height, facial features) of the guest. The show effect system may utilize a Pepper's Ghost-based technique in which an optical beam splitter (e.g., glass, half mirror) provides a realistic portrayal of combined (e.g., superimposed, combined, overlaid) imagery from a first area (e.g., imagery transmitted through the optical beam splitter) and imagery from a second area (e.g., imagery reflected from the optical beam splitter). In other words, the optical beam splitter may be arranged to enable transmission of a first imagery projected through the beam splitter and to reflect a secondary imagery projected onto the beam splitter.

In an embodiment, the guest may be positioned at a first side of the optical beam splitter, and imagery of the guest (e.g., a reflection of the guest) may deflect off the optical beam splitter and back toward the guest (e.g., with respect to a perspective of the guest). Thus, the guest may view the imagery of themselves via the optical beam splitter. Additionally, the show effect system may include a display and a mirror at a second side, opposite the first side, of the optical beam splitter. The display may project virtual imagery onto the mirror, and the mirror may be arranged (e.g., angled with respect to the optical beam splitter) to deflect the appearance of the virtual imagery through the optical beam splitter. As such, the guest may view the virtual imagery via projection through the optical beam splitter. In this way, the guest may observe the reflected imagery of themselves and the virtual imagery projected through the optical beam splitter in a combined, superimposed, or overlaid appearance via the optical beam splitter. The sensors may determine the location and/or the orientation of the guest with respect to the optical beam splitter. For example, the show effect system may adjust the projection of the virtual imagery onto the display based on the location of the guest to adjust the appearance of the virtual imagery deflected by the mirror through the optical beam splitter for viewing by the guest. The adjusted projection of the virtual imagery onto the display may realistically portray the virtual imagery with proper apparent 3D depth and dimensions with respect to a perspective of the guest corresponding to the location of the guest relative to the optical beam splitter. For example, the show effect system may achieve this by including an actuator, such as a motorized track or a robotic arm, that adjusts a position of a display and a mirror relative to one another (e.g., to move the display and the mirror away from and/or toward one another), wherein the mirror is angled to direct light from the display toward the beam splitter. Adjusting the position of the display and the mirror relative to one another may adjust the appearance of the virtual imagery via the beam splitter, such as a depth at which the virtual imagery may be positioned. In another example, the show effect system may adjust a position and/or an orientation of the beam splitter based on the orientation of the guest. This may be done alone or in conjunction with adjusting position and/or orientation of the mirror, the display, or both. The guest may be positioned at an angle with respect to the beam splitter. The beam splitter may be angled, rotated, moved, or the like based on the orientation of the guest to provide virtual imagery with proper apparent depth and dimensions with respect to the perspective of the guest. Thus, the virtual imagery may be viewed with proper apparent depth and dimension by the guest.

Additionally or alternatively, the show effect system may project the virtual imagery based on the guest being within a threshold distance (e.g., a threshold range of distances) of the show effect system (e.g., of the optical beam splitter). For example, the mirror and the display of the show effect system may be fixed relative to one another and/or relative to the optical beam splitter. Thus, the virtual imagery projected by the display onto the mirror and deflected by the mirror through the optical beam splitter may have the same 3D appearance (e.g., the same position of depth) when the display is activated. Projection of the virtual imagery when the guest is within the threshold distance may cause the virtual imagery to have a proper appearance with respect to the perspective of the guest. For example, the virtual imagery may appear as a real world object properly positioned with respect to (e.g., overlaid on) the reflected imagery of the guest. The virtual imagery may also be blocked from projection based on the guest being outside of the threshold distance of the show effect system. In this manner, when the guest is at the particular location in which the projected virtual imagery may have a realistic appearance with respect to the reflected imagery of the guest, projection of the virtual imagery may be effectuated. However, when the guest is not at the particular location in which the projected virtual imagery may have the realistic appearance with respect to the reflected imagery of the guest, the projection of the virtual imagery may be blocked. As such, the virtual imagery may be selectively projected to have the proper appearance (e.g., apparent depth) from the guest's perspective. For example, the virtual imagery may appear to be at a same or substantially similar depth as the guest.

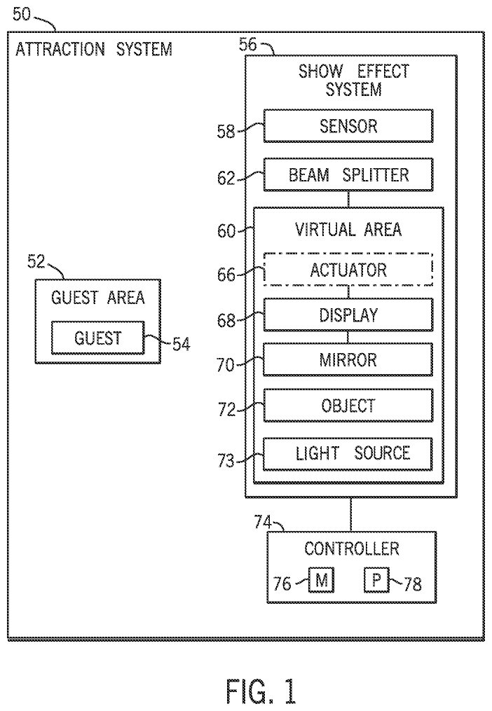

With the foregoing in mind, FIG. 1 is a schematic diagram of an embodiment of an attraction system 50 of an amusement park. As an example, the guest area 52 may include a path (e.g., a walkway, a queue, a line) through which guest(s) 54 may navigate. As another example, the guest area 52 may include a space (e.g., a seating area, standing area) where the guest(s) 54 may be positioned to view a performance. As a further example, the guest area 52 may include a ride vehicle that may move and carry the guest(s) 54 throughout the attraction system 50.

Furthermore, the attraction system 50 may include a show effect system 56 (e.g., a Pepper's Ghost-based system) that may provide entertainment to the guest(s) 54 located in the guest area 52 and/or within the attraction system 50. For example, the show effect system 56 may provide an immersive experience for the guest(s) 54. The show effect system 56 may include a sensor 58 (e.g., representative of one or more sensors) that generates sensor data associated with the guest(s) 54, a virtual area 60 (e.g., augmented reality scene) to provide show effects (e.g., virtual imagery projections, show effect projections) viewed by the guest(s) 54, and a beam splitter 62 between the guest area 52 and the virtual area 60. In this manner, the guest area 52 may be positioned at a first side of the beam splitter 62, and the virtual area 60 may be positioned at a second side, opposite the first side, of the beam splitter 62.

By way of example, the guest may approach the show effect system 56 via the guest area 52. The sensor 58 may be positioned to monitor guest activity associated with the guest(s) 54. For example, the guest activity may include a gesture provided by the guest(s) 54, such as movement of a body component (e.g., head, arms, legs). In another example, the guest activity may include a distance between the guest(s) 54 and the show effect system 56. To this end, the sensor 58 may include a camera (e.g., optical camera, three-dimensional (3D) camera, infrared (IR) camera, depth-based camera), a position sensor (e.g., sonar sensor, radar sensor, laser imaging, detection, and ranging (LIDAR) sensor), time of flight sensor, and the like. For example, the sensor 58 may generate video data of the guest(s) 54 (e.g., in the IR spectrum, which may not be visible to the guest(s) 54). In an embodiment, the sensor 58 may include a low latency facial and/or body tracking system. For example, the sensor 58 may include a laser-based time of flight sensor that generates sensor data at multiple hertz to track a longitudinal position of the guest(s) 54 relative to the show effect system 56. In another example, the sensor 58 may include a computer vision system that tracks a longitudinal and lateral position of the guest(s) 54 relative to the show effect system 56. In this way, rapid movement of the guest(s) 54 (e.g., body components, facial expressions) may be captured by the sensor data. In an embodiment, the guest(s) 54 may wear or otherwise possess a marker, such as IR reflective markers, ultra-violet (UV) markers, which may be tracked by the sensors 58 to determine the guest activity associated with the guest(s) 54.

The sensor 58 may generate sensor data indicative of a presence and/or a perspective (e.g., line of sight) of the guest(s) 54. For example, the sensor 58 may detect motion indicative of the guest(s) 54 approaching the show effect system 56. In another example, the sensor 58 may track one or more attributes (e.g., facial features, height, eye level) of the guest(s) 54. The show effect system 56 may then operate to provide a show effect based on such sensor data. Additionally or alternatively, the sensor data may be analyzed to determine a line of sight of the guest(s) 54, and the show effect system 56 may operate to improve visibility of the show effects.

The beam splitter 62 may combine (e.g., superimpose, overlay, misalign) the appearance of the guest(s) 54 with imagery (e.g., virtual imagery) from the virtual area 60, thereby providing show effects to the guest(s) 54. For example, the beam splitter 62 may be partially visible and partially reflective to enable transmission of imagery projected through the beam splitter 62, as well as reflection of imagery projected (e.g., based on light reflecting from the face of a guest) onto the beam splitter 62. For example, the beam splitter 62 may reflect light from the viewing area as reflected imagery back to the guest(s) 54. Indeed, the beam splitter 62 may reflect imagery of the guest(s) 54 positioned adjacent to the beam splitter 62 to enable the guest(s) 54 to view the reflected imagery of themselves. Additionally, the beam splitter 62 may enable the guest(s) 54 to view the virtual imagery projected from the virtual area 60 through the beam splitter 62. As such, the guest(s) 54 may view both the reflected imagery and the virtual imagery via the beam splitter 62. The beam splitter 62 may facilitate this operation based on the nature of the material forming the beam splitter 62. For example, the beam splitter 62 may be made from a material, such as glass, plastic, a foil, and/or a semi-transparent mirror, that includes both transmissive and reflective properties to enable the guest(s) 54 to view reflected imagery and transmitted imagery via the beam splitter 62.

The virtual area 60 may include various components configured to generate and project virtual imagery with accurate appearance of depth (e.g., with respect to the appearance of the guest(s) 54). For example, the virtual area 60 may include an actuator 66 (e.g., linear actuator, rotational actuator), a display 68, and a mirror 70. The display 68 may include any suitable display (e.g., liquid crystal display (LCD), light emitting diode (LED) display, organic light emitting diode (OLED) display, micro-LED) that receives image data and projects (e.g., displays) the image data as virtual imagery. The display 68 may project the virtual imagery onto the mirror 70, and the mirror 70 may deflect the virtual imagery through the beam splitter 62 for viewing by the guest(s) 54. Thus, the virtual imagery projected by the display 68 may supplement the reflected imagery of the guest(s) 54. The display 68 may adjust or manipulate the virtual imagery to enhance (e.g., distort, alter, superimpose, interact with) the reflected imagery of the guest(s) 54. For example, the virtual image may include a goblin effect that transforms the appearance of the guest(s) 54 (e.g., as viewed from the guest's perspective) into a goblin. In one embodiment, the display 68 may include a two-dimensional (2D) display. In an additional or alternative embodiment, the display 68 may include a 3D or volumetric display, such as an autostereoscopic display, a light field display, and the like. Still in other embodiments, the display 68 may include a tracked 3D surface that is projection mapped by a projection system within the display 68. For example, the display 68 may include a flexible display shaped like a face, and the virtual imagery may be a face shaped mask that may be positioned to match the guest's distance and pose. In this way, the virtual imagery may be projected to align with reflected imagery of the guest's face.

The actuator 66 may be coupled to the display 68 and/or the mirror 70 and may adjust a position and/or orientation of the display 68 and/or the mirror 70 based on sensor data. For instance, the actuator 66 may move the display 68 and/or the mirror 70 along one or more motorized track(s), such as in directions (e.g., a lateral direction, a vertical direction) along the plane of the beam splitter 62 and/or in directions (e.g., longitudinal directions) crosswise to the plane of the beam splitter 62. Movement of the display 68 and/or the mirror 70 along the beam splitter 62 may move the position of the virtual imagery viewed by the guest(s) 54 along the beam splitter 62. Movement of the display 68 and/or the mirror 70 crosswise to the plane of the beam splitter 62 may adjust an apparent depth of the virtual imagery. In another example, the actuator 66 may adjust a relative position between the display 68 and the mirror 70 to adjust the apparent depth of the virtual imagery. The distance of the apparent depth of the virtual imagery (e.g., with respect to the beam splitter 62) may be based on the distance between the display 68 and the mirror 70. For example, increasing a distance between the display 68 and the mirror 70 by one centimeter (cm) (e.g., 0.4 inches (in)), such as by moving the mirror 70 and/or display 68 away from one another, may increase an apparent depth of the virtual imagery by two cm (e.g., 0.8 in). Movement of the display 68 and/or the mirror 70 relative to one another to adjust the apparent depth of the virtual imagery may reduce an amount of torque and/or power consumed by the actuator 66, compared to using the actuator 66 (or other actuators) to move each of the mirror 70 or the display 68 with respect to (e.g., toward, away from, left, right) the beam splitter 62. Additionally or alternatively, the actuator 66 may adjust an angle (e.g., tilt) between the mirror 70 and the display 68. Adjusting the angle between the mirror 70 and the display 68 may adjust an appearance of the virtual imagery, such as an angle in which virtual imagery appears when viewed by the guest(s) 54. If any distortion would result from changing this angle, in some embodiments the virtual imagery may be adjusted to offset the distortion.

In certain instances, the beam splitter 62 may include a visual barrier to conceal the virtual area 60 from the guest's perspective and/or limit the show effect to particular guest(s) 54 looking directly at the beam splitter 62. For example, the beam splitter 62 may be covered with the visual barrier (e.g., a fabric (e.g., black cloth), film, (e.g., privacy film)). In this way, ambient light in the virtual area 60 may be reduced or blocked by the visual barrier. For example, reducing ambient light in the virtual area 60 may enable the guest(s) 54 to view the projected virtual imagery more clearly and better obscure direct observation of the display 68 and/or the mirror 70 through the beam splitter 62. In another example, the show effect system 56 may have multiple guests 54 viewing the show effect system 56. However, the show effect projections may appear distorted or altered when the guest(s) 54 are not looking at the beam splitter 62 from a particular angle. For example, the guest(s) 54 may perceive the imagery from the virtual area 60 to be incorrectly combined with the appearance of the reflected imagery of guest when viewing the beam splitter 62 from an undesirable angle. To this end, the visual barrier may reduce or block certain guest(s) 54 from viewing the show effect at the undesirable angle. For example, the visual barrier may cause light to travel through the beam splitter 62 perpendicularly with respect to a plane along which the beam splitter 62 extends such that the show effect may not be visible by the guest(s) 54 looking at the beam splitter 62 from an oblique angle instead of at a perpendicular angle.

In an embodiment, the beam splitter 62 may be coupled to an actuator (e.g., linear actuator, rotational actuator) that may adjust a position and/or an orientation of the beam splitter 62 based on the position and/or the orientation of the guest(s) 54. When the guest(s) 54 looks at the beam splitter 62 from an angle, the position and/or the orientation of the beam splitter 62 may be adjusted to match the angle of the guest(s) 54. Movement of the beam splitter 62 (e.g., towards the guest(s) 54, away from the guest(s) 54) may adjust the position of the reflected imagery and/or the virtual imagery as viewed by the guest(s) 54. In addition, adjustment of the orientation (e.g., rotational movement) may adjust an appearance of the reflected imagery and/or the virtual imagery. For example, a position of an edge of the beam splitter 62 may be adjusted such that the beam splitter 62 may be rotated. In certain instances, the visual barrier may not be used to reduce or block guest(s) 54 from viewing the show effect projections. As such, a viewing area may be expanded by adjusting the position and/or the orientation of the beam splitter 62. As previously noted, the beam splitter 62 may also be adjusted in conjunction with adjustments to orientation and/or positioning of other features (e.g., the display 68 and mirror 70) to achieve desired results (e.g., accommodating the point of view of a particular guest).

The virtual area 60 may also include an object 72 positioned in the virtual area 60. The guest(s) 54 may be able to view the object 72 through the beam splitter 62. For example, the object 72 may be viewed as a transmitted image through the beam splitter 62. In certain instances, the object 72 may include a physical object, such as a prop, an animated figure, a person (e.g., a costumed performer), or any other suitable physical object placed within the virtual area 60 to create an interactive experience for the guest(s) 54. For example, the object 72 may provide an appearance of a virtual environment in which the reflected imagery of the guest(s) 54 may be positioned. Thus, the object 72 may further provide realistically appearing show effects to the guest(s) 54. In certain instances, the actuator 66 may be coupled to the physical object and may adjust a position of the physical object based on sensor data. For example, the actuator 66 may adjust the appearance of the physical object, as viewed by the guest(s) 54, relative to the reflected imagery of the guest(s) 54 and/or relative to the beam splitter 62.

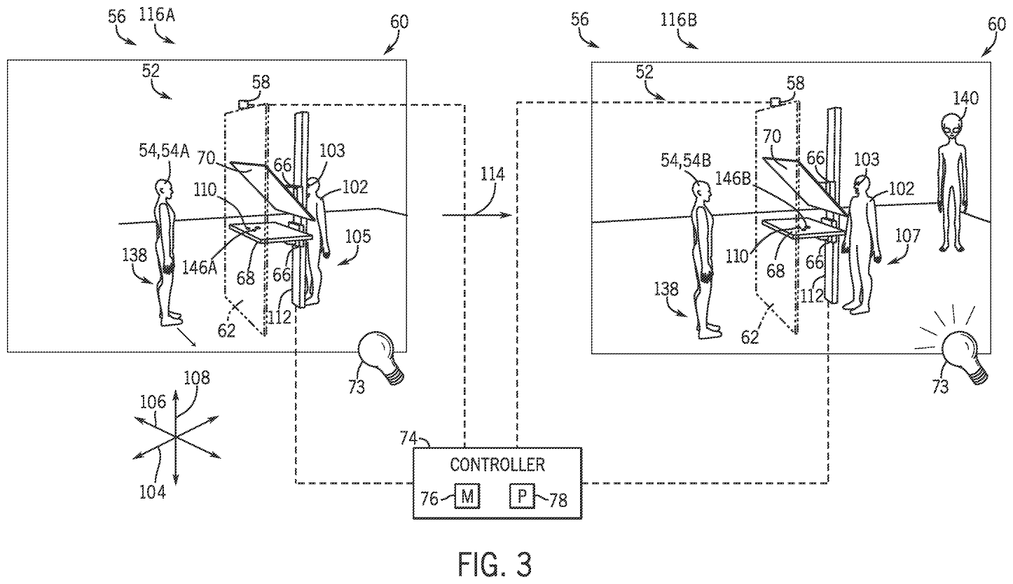

In certain instances, a light source 73 (e.g., LED, OLED, light bulb) may be used to illuminate the object 72 and/or adjust a lighting of the virtual area 60 to improve visibility of the object 72. For instance, in an embodiment in which ambient light in the virtual area 60 is limited, the light source may enable the guest(s) 54 to view the object 72 more clearly. As further described with respect to FIG. 3, the light source 73 may be modulated to illuminate the virtual area 60 to adjust visibility of the virtual image, imagery of the virtual area 60, or a combination thereof. In other instances, the object 72 may be an additional virtual imagery projected through the beam splitter 62, such as without the mirror 70. For example, an additional display may directly project the object 72 through the beam splitter 62 without initially deflecting the imagery of the object 72 off a mirror (e.g., the mirror 70).

The show effect system 56 may include a controller 74 (e.g., a control system, an automated controller, a programmable controller, an electronic controller, control circuitry, a cloud-computing system) configured to instruct the operation of the show effect system 56 to provide the interactive experience to the guest(s) 54. The controller 74 may include a memory 76 and a processor 78 (e.g., processing system, processing circuitry). The memory 76 may include volatile memory, such as random-access memory (RAM), and/or non-volatile memory, such as read-only memory (ROM), optical drives, hard disc drives, solid-state drives, or any other non-transitory computer-readable medium that includes instructions to operate the show effect system 56. The processor 78 may be configured to execute such instructions. For example, the processor 78 may include one or more application specific integrated circuits (ASICs), one or more field programmable gate arrays (FPGAs), one or more general purpose processors, or any combination thereof.

The controller 74 may receive sensor data from the sensor 58 and instruct the operation of the show effect system 56 based on a position and/or an orientation of the guest 54 (e.g., relative to the beam splitter 62), as determined from the sensor data. For example, using the sensor data, the controller 74 may use image analysis techniques to determine a position of the guest(s) 54 relative to the beam splitter 62, such as a distance between the guest(s) 54 and the beam splitter 62. In another example, the controller 74 may use image analysis techniques to determine the orientation of the guest(s) 54 relative to the beam splitter 62, such as an angle of the guest(s) 54 relative to the beam splitter 62, a line of sight of the guest(s) 54, a viewing direction of the guest(s) 54, and the like. The controller 74 may then determine a target position of the virtual imagery viewed by the guest(s) 54 based on the position and/or the orientation of the guest(s) 54. The controller 74 may identify a corresponding position and/or orientation of the display 68 and the mirror 70 relative to the beam splitter 62 and/or relative to one another to enable the display 68 to project the virtual imagery to appear at the target position. In certain instances, the controller 74 may determine a corresponding position and/or orientation of the beam splitter 62. To this end, the controller 74 may utilize data from a high speed, low latency computer vision face tracking system to identify the position and/or the orientation of the guest(s) 54 relative to the beam splitter 62 and instruct adjusting a position of the display 68 and/or of the mirror 70 based on the position of the guest(s) 54. Thus, the position and/or the orientation of the projected virtual imagery may more accurately correspond to the position of the guest(s) 54.

By way of example, the controller 74 may operate to cause the projected virtual imagery to have an apparent depth that matches that of the reflected imagery of the guest(s) 54. For instance, the projected virtual imagery may include a clothing item, and matching the apparent depth of the projected virtual imagery with the apparent depth of the reflected imagery of the guest(s) 54 may provide an appearance of the guest(s) 54 wearing the clothing item. To this end, the controller 74 may instruct the actuator 66 to position the display 68 and/or the mirror 70 at a distance relative to the beam splitter 62 that matches (or substantially matches) the relative distance between the guest(s) 54 and the beam splitter 62. The controller 74 may also monitor movement data of the guest(s) 54 and instruct the actuator 66 to adjust the position of the display 68 and/or of the mirror 70 based on the monitored movement data. For example, in response to determining the guest(s) 54 move towards (e.g., in the longitudinal direction) the beam splitter 62, the controller 74 may instruct the actuator 66 to move the display 68 and the mirror 70 towards the beam splitter 62 and/or to move the display 68 and the mirror 70 toward one another. In response to determining movement of the guest(s) 54 in a lateral direction (e.g., to the left, to the right) relative to the beam splitter 62, the controller 74 may instruct the actuator 66 to move the mirror 70 and the display 68 in the corresponding lateral direction.

In an additional or alternative embodiment, the controller 74 may instruct delaying adjustment of the position of the display 68 and/or of the mirror 70 based on the position of the guest(s) 54. The delayed adjustment of the position of the display 68 and/or of the mirror 70 may provide a different show effect experience to the guest(s) 54. By way of example, the virtual imagery may include an outline that surrounds the guest(s) 54. Delayed movement of the display 68 and/or of the mirror 70 may delay movement of the outline, which may provide an apparitional appearance of the outline corresponding to a previous position of the guest(s) 54. The apparitional appearance otherwise may not be provided via more immediate adjustment of the position of the display 68 and/or of the mirror 70 based on the position of the guest(s) 54.

In certain instances, the actuator 66 may have a minimum or maximum allowable range (e.g., in the longitudinal direction, the lateral direction, the vertical direction) of movement. For example, the controller 74 may block movement of the display 68 and/or of the mirror 70 beyond certain portions along a motorized track. In response to determining the position of the display 68 and/or of the mirror 70 may be beyond the allowable range based on the guest's position, the controller 74 may block presentation of the virtual imagery via the display 68. Thus, the virtual imagery may not be presented to the guest(s) 54 at certain locations of the guest area 52.

Additionally or alternatively, the controller 74 may determine attributes, such as facial features (e.g., eye position, nose position, mouth position, facial expressions) of the guest(s) 54 based on the sensor data to identify corresponding image data to transmit to the display 68 to project the virtual imagery. For example, the controller 74 may instruct adjusting a size, shape, color, and so on of the virtual imagery based on the attributes of the guest(s) 54. In an embodiment, the controller 74 may determine a height of the guest(s) 54 and instruct adjusting a size of the virtual imagery projected by the display 68 to align the appearance of the guest(s) 54 with the virtual imagery. For example, the virtual imagery may include a mask overlaid on the reflected imagery of the guest's face to provide an appearance that the guest(s) 54 is wearing the projected virtual imagery of the mask. The controller 74 may instruct the display 68 to project the virtual imagery of the mask such that the dimensions of the virtual imagery of the mask correspond to dimensions of the guest's face to properly overlay the virtual imagery of the mask to appear to be worn by the guest(s) 54. In another example, the controller 74 may instruct the display 68 and/or the mirror 70 to adjust a position in order for the dimensions of the virtual imagery to correspond with the dimensions of the guest's face. As such, the controller 74 may determine the various attributes of the guest(s) 54 based on the sensor data to determine a size and/or placement of the facial features to cause the projected virtual imagery of the mask to have an appearance that accommodates the size and/or placement of the facial features. Thus, the show effect system 56 may provide an appearance of the guest(s) 54 wearing the projected virtual imagery of the mask in a convincing manner. It should also be noted that light intensity associated with the mask (e.g., brightness of an image of the mask on the display 68) may be adjusted based on detected lighting to control the mask to a desired level of perceived opaqueness or translucency.

Moreover, the controller 74 may instruct the display 68 to adjust projection of the virtual imagery based on movement of the guest(s) 54, as indicated by adjustment of the facial features of the guest(s) 54. The guest(s) 54 may turn their head, such as to turn their cheek to face the beam splitter 62 or to tilt their chin or their forehead to face the beam splitter 62. As a result, the reflected imagery of the guest's face may be adjusted. In certain instances, the position and/or the orientation of the beam splitter 62 may be adjusted such that the guest(s) 54 appears to wear the mask in a convincing manner. In other instances, the controller 74 may determine the movement of the guest(s) 54 and/or the adjustment to the reflected imagery of the guest's face and may instruct the actuator 66 to tilt or rotate the display 68 so that the guest(s) 54 appears to wear the mask. For example, the dimensions of the projected imagery may be adjusted to fit and conform to the adjusted facial features of the guest(s) 54.

In another example, the sensor data may include other information regarding the guest(s) 54, such as a position and/or an orientation of appendages of the guest(s) 54. By way of example, the virtual imagery may include a costume to be overlaid on the body of the reflected imagery of the guest(s) 54. For this reason, the controller 74 may determine a stance of the guest 54, such as a position of the guest's arms, legs, torso, feet, based on the sensor data. The controller 74 may then instruct the display 68 to project the virtual imagery of the costume based on the stance to provide an appearance that the guest(s) 54 is wearing the projected virtual imagery of the costumer in a convincing manner. For example, the controller 74 may instruct the display 68 to project the virtual imagery of the costume to conform to positioning of various body components of the guest(s) 54. Based on movement of the guest(s) 54 that may cause the various body components to move, the controller 74 may instruct the display 68 to change a corresponding appearance of the virtual imagery.

As previously mentioned, the object 72 may be viewable through the beam splitter 62 along with the virtual imagery provided by the display 68. As with the display 68, the object 72 may also be controlled. For example, the controller 74 may instruct the actuator 66 (which may represent one or more actuators operating together or separately) to adjust a position of the object 72 based on the position of the guest(s) 54. For example, the object 72 may include a physical hat that appears to be worn by the guest(s) 54 (e.g., superimposed onto the reflected imagery viewed from the guest's perspective). The controller 74 may instruct the actuator 66 to adjust a position, shape, orientation or other aspect of the object 72 based on the determined movement of the guest(s) 54.

In an embodiment, multiple show effect systems 56 may be adjacently positioned within the attraction system 50. For example, the beam splitter 62 of each show effect system 56 may be aligned to appear as a continuous, unitary, or integral piece with respect to the guest's perspective. Multiple guests 54 may be within the guest area 52, and a respective show effect system 56 may be provide show effects to each different guest 54 to provide virtual imageries that appear to be properly positioned (e.g., having an apparent depth) for each of the guest's different perspectives.

Moreover, in an embodiment (e.g., in which the position of the display 68 and/or the mirror 70 may be fixed) the controller 74 may instruct the display 68 to project the virtual imagery in response to determining the guest(s) 54 are within a threshold distance (e.g., a threshold range of distances) relative to the beam splitter 62. For example, projection of the virtual imagery via the display 68 when the guest(s) 54 are within the threshold distance relative to the beam splitter 62 may cause the virtual imagery to appear at a proper position (e.g., a proper depth) with respect to the reflected imagery of the guest(s) 54. As an example, the distance between the beam splitter 62 with respect to the display 68 and/or the mirror 70 may be same as the threshold distance. As such, the virtual imagery may have an apparent depth that matches the reflected imagery of the guest(s) 54.

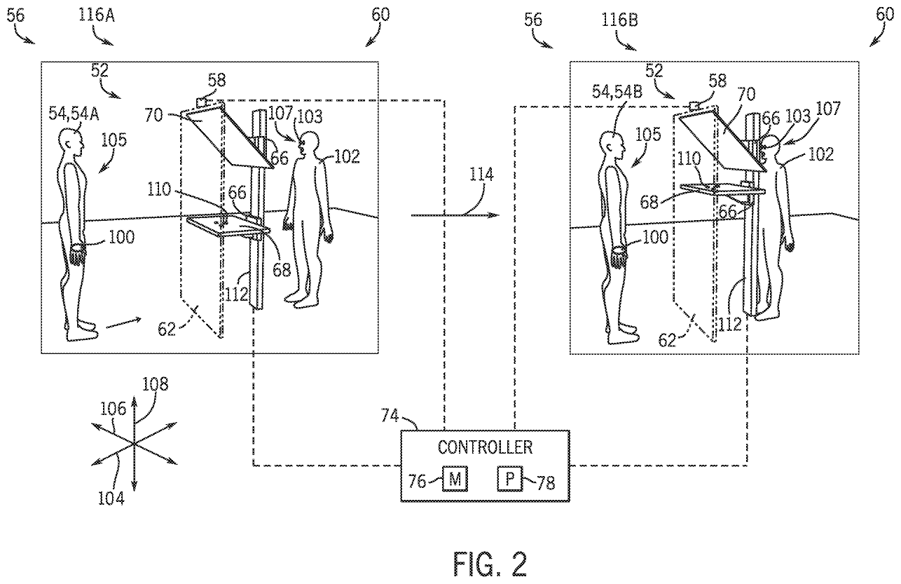

FIG. 2 is a side perspective view of the show effect system 56. In particular, FIG. 2 depicts the guest 54 standing in a first position 105 and looking at the show effect system 56 and moving to a second position 107. The guest 54 may view reflected imagery 102 at an apparent depth equivalent to a distance between the guest 54 and the beam splitter 62. Components of the virtual area 60 may generate and project virtual imagery 110 (e.g., one or more virtual images) that combines with the reflected imagery 102. For example, the controller 74 may cause a position of the display 68 and/or the mirror 70 to be a similar distance from the beam splitter 62 as the distance between the guest 54 and the beam splitter 62. In this way, the projected virtual image 110 may be transmitted through the beam splitter 62 as the transmitted imagery 103 and appear to be at same or substantially similar apparent depth as the reflected imagery 102. Indeed, the reflected imagery 102 and the transmitted imagery 103 may be combined to create the show effect projection. Moreover, the apparent depth may be taken into account when adding virtual imagery 110 to the reflected imagery 102 because the virtual imagery 110 should coordinate properly with the reflected imagery 102. For example, virtual clothing should fit the reflected imagery 102 of the guest 54.

In the illustrated show effect system 56, a sensor 58 may be positioned to track movement of the guest 54 in the guest area 52 and relative to the beam splitter 62. The guest 54 may wear or otherwise be in possession of a marker 100 to facilitate tracking of the movement of the guest 54 via the sensor 58. For example, the sensor 58 may monitor a position of the guest 54 along a longitudinal direction 104, a lateral direction 106, and/or a vertical direction 108 with respect to the beam splitter 62. The show effect system 56 also includes the virtual area 60 in which the actuator 66, the display 68, and the mirror 70 may be positioned. Reflection of the guest 54 via the beam splitter 62 may provide reflected imagery 102 of the guest 54, and the reflected imagery 102 may appear to be at a first position 105 (e.g., located within the virtual area 60). Additionally, the display 68 may project virtual imagery 110 onto the mirror 70 for deflection from the mirror 70 through the beam splitter 62. As a result, the virtual imagery 110 may be visible to the guest 54 as transmitted imagery 103 that appears to be at a second position 107 (e.g., located within the virtual area 60). The combination of the reflected imagery 102 and the transmitted imagery 103 may be perceived as a show effect by the guest 54. Although the illustrated display 68 includes a 2D display that may generate 2D virtual imagery 110 for deflection off the mirror 70 and viewing by the guest 54, the display 68 may include a large stereoscopic or light field-based display system that may generate 3D virtual imagery 110 for deflection off the mirror 70 and viewing by the guest 54.

Returning to the sensor 58, the sensor 58 may be positioned adjacent to (e.g., on top of, on a lateral side of) or embedded within the beam splitter 62. The sensor 58 may generate sensor data associated with the guest 54 during operation of the show effect system 56. The sensor data may include an attribute of the guest 54, a position of the guest 54, and/or an orientation of the guest 54. The show effect system 56 may include and the illustrated sensor 58 may represent any suitable number of sensors 58 to provide accurate sensor data associated with the guest 54.

In an embodiment, the guest 54 may wear or be in possession of the marker 100, which may be tracked by the sensor 58. The marker 100 may include an illuminated color or infrared (IR) light-emitting diode (LED), passive reflective markers, a printed pattern (e.g., QR code or other type of barcode) or known marker, or the like. For example, the marker 100 may be a printed pattern on a prop, such as a hat, headpiece, clip, and so on. The guest 54 may wear the prop, and the sensor 58 may generate sensor data indicative of the marker 100. The controller 74 may receive the sensor data generated by the sensor 58 and determine a location of the marker 100 based on the sensor data to determine the position of the guest 54. In an embodiment, the marker 100 may include a wired or wireless communication device communicatively coupled to the sensor 58, such as an AR headset device, a mobile phone, a radio frequency (RF) position-based wearable, and the like. For example, the marker 100 may include the RF position-based wearable, such as a watch, glasses, or a mask, embedded with an ultra-wide band (UWB) tracking beacon that transmits signals to the sensor 58. The signals may include a position of the marker 100 within the guest area 52, which may be associated with the position of the guest(s) 54 within the guest area 52.

The controller 74 may instruct the actuator 66 (which may represent one or more actuators that operate together or separately) to adjust a position of the display 68 and/or of the mirror 70 based on the received sensor data. For example, the display 68 and/or the mirror 70 may be coupled to a track 112 extending along the vertical direction 108, and the controller 74 may instruct the actuator 66 to move the display 68 and/or the mirror 70 along the track 112 (e.g., along the vertical direction 108). For example, the controller 74 may instruct the actuator 66 to adjust a position of the display 68 and/or the mirror 70 relative to one another along the vertical direction 108 to adjust an apparent depth of the transmitted imagery 103, thereby adjusting the second position 107 of the transmitted imagery 103. In certain instances, the mirror 70 may remain fixed at a line of sight (e.g., vertically aligned with guest's perspective) of the guest 54, and the controller 74 may instruct the actuator 66 to move the display 68 relative to the mirror 70. For this reason, the display 68 may project the virtual imagery 110, and the mirror 70 may deflect the virtual imagery 110 through the beam splitter 62 to the line of sight of the guest 54, thus reducing image distortion that may otherwise occur as a result of misalignment between the deflection of the virtual imagery 110 and the line of sight of the guest 54.

In the illustrated example, the guest 54 is positioned in front of the beam splitter 62 and may move towards the beam splitter 62 along the longitudinal direction 104. Indeed, FIG. 2 shows the movement, as indicated by arrow 114 from a first configuration 116A to a second configuration 116B. Movement of the guest 54 along the longitudinal direction 104 toward the beam splitter 62 may change the apparent depth associated with the first position 105 of the reflected imagery 102 along the longitudinal direction 104. Such change is depicted by the differences in the first configuration 116A and the second configuration 116B. For example, the reflected imagery 102 may increase in size, may appear to be positioned closer to the beam splitter 62, or both. The controller 74 may operate the show effect system 56 to provide a desirable appearance of the transmitted imagery 103 with respect to the reflected imagery 102. For example, the controller 74 may operate to adjust an apparent depth associated with the second position 107 of the transmitted imagery 103 based on the apparent depth associated with the first position 105 of the reflected imagery 102. To this end, the controller 74 may receive the sensor data (e.g., associated with the marker 100, associated with the guest 54), determine the position and/or the orientation of the guest 54 relative to the beam splitter 62 based on the sensor data, and transmit a signal to instruct the actuator 66 to adjust a position and/or an orientation of the display 68 and/or the mirror 70 based on the position and/or orientation of the guest 54 relative to the beam splitter 62. For example, the controller 74 may instruct the actuator 66 to move the display 68 along the vertical direction 108 to change the distance between the display 68 and the mirror 70, thereby adjusting the apparent depth associated with the second position 107 of the transmitted imagery 103 (e.g., to align the second position 107 of the transmitted imagery 103 (e.g., mask aligned with the guest's face) and the first position 105 of the reflected imagery 102 with one another, thereby maintaining overlay of the transmitted imagery 103 onto the reflected imagery 102). In an embodiment, decreasing the distance between the display 68 and the mirror 70 may result in the transmitted imagery 103 appearing to be positioned closer to the beam splitter 62. Thus, in response to determining the guest 54 is moving toward the beam splitter 62, thereby causing the first position 105 of the reflected imagery 102 to appear closer to the beam splitter 62, the controller 74 may instruct the actuator 66 to move the display 68 and the mirror toward one another, thereby causing the second position 107 of the transmitted imagery 103 to appear closer to the beam splitter 62.

In an embodiment, the actuator 66 may include a multi-axis actuator system that may move the display 68 and/or mirror 70 along the longitudinal direction 104 and/or the lateral direction 106 (e.g., along respective tracks). As an example, the actuator 66 may move the display 68 and/or the mirror 70 along the longitudinal direction 104 to adjust the apparent depth associated with the second position 107 of the transmitted imagery 103. As another example, the guest 54 may move in the lateral direction 106 relative to the beam splitter 62, thereby moving the first position 105 of the reflected imagery 102 along the lateral direction 106. In response, the actuator 66 may move the display 68 and/or the mirror 70 along the lateral direction 106 to correspondingly adjust the second position 107 of the transmitted imagery 103 along the lateral direction 106. Such additional movements of the display 68 and/or of the mirror 70 may further enable control of the appearance of the show effects provided to the guest 54. The actuator 66 may also adjust an angular position of the mirror 70 and/or the display 68. Coordinated angle adjustments of the display 68 and/or the mirror 70 may achieve desired image distortion or offset image distortions. Further, imagery provided by the display 68 may be adjusted based on positioning changes to the mirror 70 and/or the display 68 and such changes in the imagery may be done to create a smooth transition or to intentionally add distortion to the transmitted imagery 103.

In an embodiment, the position and/or the orientation of the beam splitter 62 may be adjusted (e.g., via an actuator) based on the position and/or the orientation of the guest 54. For example, the guest 54 may be positioned in front of the beam splitter 62 and may move towards the beam splitter 62 along the longitudinal direction 104. The controller 74 may instruct the actuator to move the beam splitter 62 along the longitudinal direction 104 to change the distance between the guest 54 and the beam splitter 62, which may change the apparent depth associated with the reflected imagery 102. In certain instances, changing the position of the beam splitter 62 may change a distance between the beam splitter 62 and the display 68 and/or the mirror 70, which may adjust the apparent depth associated with the transmitted imagery 103. As such, the reflected imagery 102 and the transmitted imagery 103 may be combined with proper apparent depth to provide the show effect. In another example, the guest 54 may view the beam splitter 62 at an angle. The controller 74 may determine an orientation of the guest 54 relative to the beam splitter 62 based on the sensor data and instruct the actuator to adjust an orientation of the beam splitter 62. For example, an edge of the beam splitter 62 may be rotated such that the guest 54 may view the beam splitter 62 at a perpendicular angle. As such, the guest 54 may view the show effect projections with reduced or eliminated distortions.

FIG. 3 is a side perspective view of the show effect system 56. For example, the guest 54 may move in the lateral direction 106 and the sensors 58 may track the movement of the guest 54 such that the projected virtual image aligns with the reflected imagery 102 of the guest 54. In particular, FIG. 3 depicts the guest 54 standing in a first position 105 and moving to a second position 107, wherein the transition is designated by arrow 114.

The controller 74 may instruct the actuator 66 to move the mirror 70 based on the sensor data received from the sensor 58 and associated with the guest 54. For example, as discussed herein, it may be desirable to align the mirror 70 with a line of sight of the guest 54 to enable the virtual imagery 110 (e.g., as projected by the display 68 and deflected off the mirror 70) to have a desirable (e.g., undistorted) appearance when viewed by the guest 54. For this reason, the controller 74 may determine a line of sight of the guest 54 and instruct the actuator 66 to move the mirror 70 based on the line of sight of the guest 54. By way of example, a first guest 54, 54A may include an adult having a relatively taller height, and a second guest 54, 54B may include a child having a relatively shorter height. The controller 74 may instruct the actuator 66 to move the mirror 70 to align with the height of the guests 54. For example, the controller 74 may instruct the actuator 66 to move the mirror 70 along the vertical direction 108 (e.g., downwardly) to change alignment of the mirror 70 from alignment with the first guest 54, 54A to alignment of the mirror 70 with the second guest 54, 54B. While FIG. 2 shows first guest 54, 54A, FIG. 2 may be apply to any guest 54. While FIG. 3 shows the second guest 54, 54B, FIG. 3 may apply to any guest 54. Additionally or alternatively, the controller 74 may identify facial features (e.g., eye position) of the guest 54 from the sensor data to determine a line of sight of the guest 54. Based on the eye position, the controller 74 may instruct the actuator 66 to adjust the position of the display 68 and/or the mirror 70.

As discussed herein, the guest 54 may move relative to the beam splitter 62 during operation of the show effect system 56, such as along the lateral direction 106. In addition to or as an alternative to movement of the display 68 and/or the mirror 70 along the lateral direction 106 based on the movement of the guest 54, the controller 74 may instruct the display 68 to adjust a location from which the virtual imagery 110 is projected from the display 68. Thus, the location at which the virtual imagery 110 is projected onto the mirror 70 and the second position 107 of the transmitted imagery 103 deflected off the mirror 70 may also be adjusted. For example, the controller 74 may instruct the display 68 to project the virtual imagery 110 from a first location 146A on the display 68 onto the mirror 70 based on a position 138 of the guest 54 along the lateral direction 106. The guest 54 may move along the lateral direction 106, and the controller 74 may instruct the display 68 to project the virtual imagery 110 from a second location 146B on the display 68 onto the mirror 70 based on an updated position 138 of the guest 54 along the lateral direction 106. For example, adjustment of the projection of the virtual imagery 110 from the first location 146A to the second location 146B may correspond to adjustment of the guest 54 along the lateral direction 106. In this way, the second position 107 of the transmitted imagery 103 with respect to the first position 105 of the reflected imagery 102 may be maintained.

In addition to the actuator 66, the display 68, and the mirror 70, the illustrated show effect system 56 includes an animated FIG. 140 (e.g., the object 72 described with respect to FIG. 1) and a light source 73 disposed within the virtual area 60. The animated FIG. 140 may be visible through the beam splitter 62 to the guest 54. Thus, the guest 54 may be able to see the animated FIG. 140 in addition to the reflected imagery 102 and the transmitted imagery 103. In this manner, the animated FIG. 140 may further enhance the show effects provided to the guest 54. In an embodiment, movements of the animated FIG. 140 may be coordinated with other aspects of the system (e.g., imagery from the display 68) to enhance immersion. It should be noted that the mirror 70 may be partially transparent to enable the guest 54 to view the animated FIG. 140 through the mirror 70 and also through the beam splitter 62.

The light source 73 may be modulated to increase or decrease visibility of the reflected imagery 102, of the transmitted imagery 103, and/or of the animated FIG. 140. For example, increasing light in the virtual area 60 may increase visibility of the animated FIG. 140 as viewed by the guest 54. Decreasing light in the virtual area 60 may increase visibility of the transmitted imagery 103 as viewed by the guest 54. As an example, the light source 73 may be dimmed to conceal or reduce visibility of the virtual area 60 from the perspective of the guest 54, such as of the track 112, while still enabling sufficient visibility of the animated FIG. 140. In an additional or alternative embodiment, the light source 73 may include one or more additional light source(s) positioned in the guest area 52 may be used to adjust visibility of the reflected imagery 102, of the transmitted imagery 103, and/or of the animated FIG. 140. The light source 73 may be used in conjunction to adjust the lighting of the virtual area and/or the guest area 52. For example, increasing the light in the guest area 52 may increase visibility of the reflected imagery 102 as viewed by the guest 54, and decreasing the light in the guest area 52 may increase visibility of the animated FIG. 140 as viewed by the guest 54.

In certain instances, the controller 74 may instruct an actuator (e.g., linear actuator, rotational actuator) to move, rotate the animated FIG. 140 based on sensor data indicative of the position of the guest 54. For example, the animated FIG. 140 may move along the lateral direction 106 in response to the guest 54 moving along the lateral direction 106. In this way, the animated FIG. 140 may appear to interact with or respond to movement of the guest 54, such as to chase the reflected imagery 102, further enhancing the show effects provided to the guest 54. The controller 74 may also adjust operation of the light source 73 (e.g., a direction in which light is emitted, an intensity at which light is emitted) in response to the movement of the animated FIG. 140 to enable the animated FIG. 140 to be viewed by the guest 54. While the virtual area 60 includes the animated FIG. 140, another physical object, such as props (e.g., icons), toys, articles of clothing (e.g., funny hats, glasses, facemask), and the like, may be positioned in the virtual area 60 in an additional or an alternative embodiment.

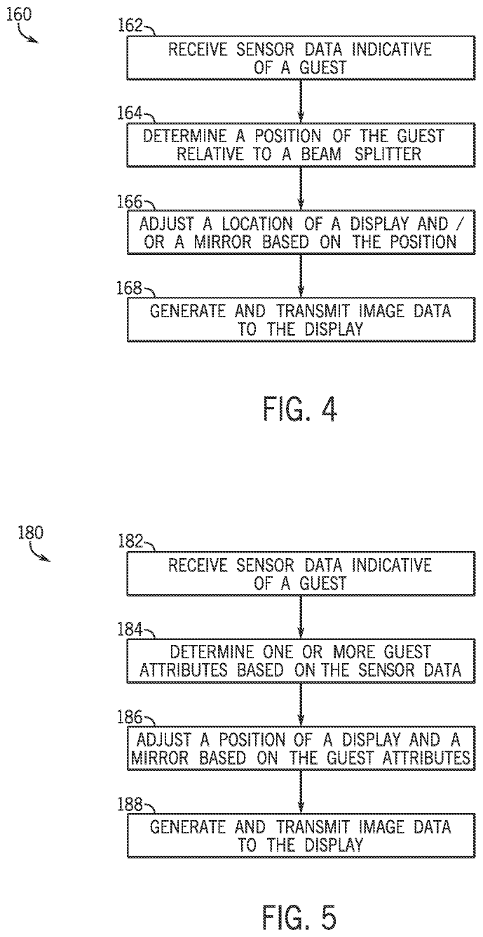

Each of FIGS. 4-6 described below illustrates a method or process for operation of the show effect system. Any suitable device (e.g., the processor 78 of the controller 74 illustrated in FIGS. 1-3) may direct the respective methods using features of the show effect system 56. In one embodiment, each method may be implemented by executing instructions stored in a tangible, non-transitory, computer-readable medium (e.g., the memory 76 of the controller 74 illustrated in FIGS. 1-3). For example, each method may be performed at least in part by one or more software components, one or more software applications, and the like. While each method is described using operations in a specific sequence, additional operations may be performed, the described operations may be performed in different sequences than the sequence illustrated, and/or certain described operations may be skipped or not performed altogether. Moreover, the respective operations of each method may be performed in any manner relative to one another, such as in response to one another and/or concurrently with one another.

With the preceding in mind, FIG. 4 is a flowchart of an embodiment of a method or process 160 for operating the show effect system to provide an immersive show effect. In an embodiment, the controller of the show effect system may track a position of the guest and generate the show effect based on a position of the guest.

At block 162, the controller may receive sensor data indicative of the guest. For example, the sensor data may be indicative of a position of the guest in the guest area. In another example, the sensor data may be associated with the marker, such as a pattern, an IR sticker, a signal from a wearable device, or the like, of which the guest may have possession.

At block 164, the controller may determine a position of the guest relative to a beam splitter, and the position of the guest relative to the beam splitter may be indicative of a line of sight of the guest. The controller may use image analysis techniques to determine a position of the guest relative to the beam splitter along the longitudinal direction, the lateral direction, the vertical direction, or a combination thereof based on the sensor data. For example, the controller may determine a distance between the guest and the beam splitter to determine the position of the guest along the longitudinal direction. In another example, the controller may determine a height of the guest and/or an eye position (e.g., an estimated eye level) of the guest to determine the position of the guest.

At block 166, the controller may instruct adjusting a location of the display and/or of the mirror of the show effect system based on the position. In an embodiment, the controller may instruct an actuator to adjust a distance between the display and the mirror based on the position of the guest. In an additional or alternative embodiment, the controller may instruct the actuator to adjust the position of the display and the mirror along the longitudinal direction, the lateral direction, and/or the vertical direction (e.g., while maintaining the relative position of the display and the mirror relative to one another).

At block 168, the controller may generate and instruct transmitting image data to the display to cause the display to project virtual imagery based on the image data. The projected virtual imagery may deflect off the mirror and be transmitted through the beam splitter to be visible to the guest as transmitted imagery. Additionally, an appearance of the guest may reflect off the beam splitter such that it is visible to the guest as reflected imagery. The transmitted imagery and the reflected imagery may combine with one another to provide an immersive show effect to the guest.

In an embodiment, the controller may generate image data and instruct transmission of the image data to cause projection of virtual imagery corresponding to or accommodating guest attributes. For example, the image data may include a funny hat that appears to be worn by the reflected imagery of the guest (e.g., as reflected by the beam splitter). A size and a shape of the hat may be generated based on a size and a shape of the guest's head (as measured by sensors or based on detection of the guest and stored guest attributes). In this way, the virtual imagery, as projected by the display, may have a more convincing appearance with respect to the reflected imagery. In another example, the controller may generate image data that partially overlays or does not overlay on the reflected imagery of the guest. For example, the controller may instruct projection of a dinosaur that appears to chase the reflected imagery of the guest. The controller may instruct the display to project the virtual imagery at a preset distance away from the reflected imagery of the guest and may adjust the image data based on the position of the guest. In certain instances, the controller may generate the image data to adjust the distance between the projected virtual imagery and the reflected imagery of the guest, such as to decrease the distance until the virtual image partially overlays on the guest.

As described herein, the projected virtual imagery may have a more realistic appearance to the guest as a result of the location of the display and/or of the mirror adjusted based on the position of the guest. For example, the apparent depth of the virtual imagery may match that of the reflected imagery of the guest. Indeed, adjusting the distance between the display and the mirror may adjust the apparent depth of the virtual imagery viewed by the guest. For example, increasing the distance between the display and the mirror may increase the apparent distance between the virtual image and the beam splitter. Additionally, the location of the display and/or of the mirror (e.g., in the lateral direction, the vertical direction) may cause the virtual imagery to be transmitted through the beam splitter at a desirable location, such as to match the location of the guest relative to the beam splitter. Further still, the location of the mirror may be aligned with the line of sight of the guest to align the virtual imagery to be aligned with the line of sight of the guest, thereby reducing distortion of the virtual imagery.

The method 160 may also be repeatedly or continually performed. For example, updated sensor data may be received, an updated position (e.g., turning, shifting) of the guest may be determined, an updated location of the display and/or of the mirror may be established, and updated image data may be generated and transmitted. Thus, the virtual imagery projected based on the image data may be updated to accommodate a change in the position of the guest to maintain a realistic appearance of the virtual imagery.

While the illustrated method or process 160 is described with respect to a single show effect system, in an embodiment, multiple show effect systems may perform the method 160 to generate the show effect for multiple guests. For example, respective actuators, such as robot appendages that may each be coupled to a display and mirror pair, may be instructed to adjust the position of multiple displays and/or of multiple mirrors to provide respective virtual imagery for each guest. In other words, each show effect system may provide respective virtual imagery that may be suitably presented to the individual guests. In one example, respective controllers may operate the different show effect systems. In another example, multiple show effect systems may be controlled by a single controller (e.g., a master controller).

FIG. 5 is a flowchart of an embodiment of a method or process 180 for operating the show effect system to provide an immersive show effect. In an embodiment, the controller may track an attribute of the guest and continuously generate the show effect based on the attribute of the guest.

At block 182, the controller may receive sensor data indicative of a guest, similar to block 162 in FIG. 4. At block 184, the controller may determine one or more guest attributes based on the sensor data. For example, the controller may determine a height, a facial feature, an orientation, and so on. The controller may also determine a body position of the guest, such as a position of the guest's arms, legs, feet, torso, and so on.

At block 186, the controller may instruct adjusting a position and/or an orientation of the display and/or the mirror based on the guest attributes. For example, the controller may determine a line of sight of the guest based on a facial feature (e.g., eye position) and instruct adjusting the position of the mirror along the vertical direction to align with the line of sight. In another example, the controller may instruct rotating the display and/or the mirror to align with the line of sight or additional guest attributes. In another example, the controller may instruct adjusting an angle in which the mirror is oriented relative to the beam splitter and/or relative to the display. In an embodiment, the controller may instruct adjusting the position and/or the orientation of the beam splitter based on the guest attributes. For example, the controller may determine an orientation of the guest relative to the beam splitter and instruct rotating the beam splitter to align with the orientation of the guest.

At block 188, the controller may generate and transmit image data to the display, similar to block 168 in FIG. 4. The controller may instruct adjusting a parameter of the image data to match the attributes of the guest. For example, the virtual imagery may include a superhero suit overlaid on the appearance of the guest. The controller may determine a stance (e.g., location of various body components) of the guest and generate the image data based on the stance to cause the virtual imagery of the superhero suit to appear more realistically worn by the guest.

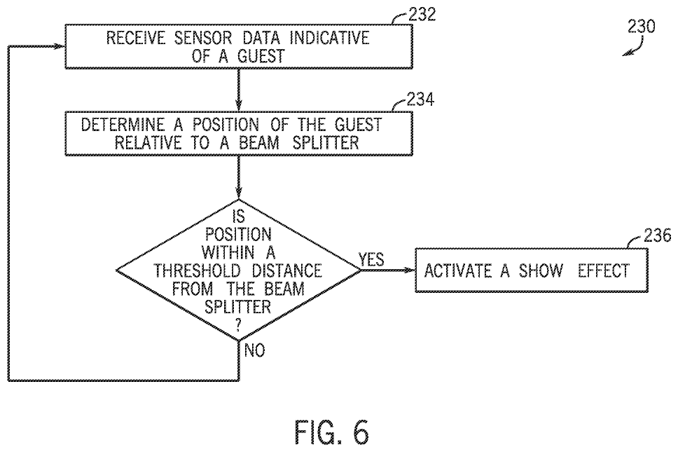

FIG. 6 is a flowchart of an embodiment of a method or process 230 for operating the show effect system to provide a realistic show effect. In an embodiment, the controller may monitor data corresponding to a position of the guest relative to a beam splitter and instruct activating a show effect in response to determining the guest is within a threshold distance of the beam splitter.

At block 232, the controller may receive sensor data indicative of a guest, similar to block 162 in FIG. 4 and block 182 in FIG. 5. At block 234, the controller may determine a position of the guest relative to a beam splitter, similar to block 164 in FIG. 4.

At block 236, the controller may determine whether the position of the guest is within a threshold distance (e.g., within a threshold range of distances) of the beam splitter. For example, the display and the mirror may be positioned at a fixed distance (or within a fixed range) from the beam splitter within the virtual area. The fixed positions of the display and the mirror may correlate to provision of desired effects to the guest when the guest is positioned at approximately the threshold distance from the beam splitter. When the mirror and/or the display have a range of positions, the threshold may vary with the range.

In response to determining the position of the guest is within the threshold distance, the controller may instruct activating a show effect, similar to block 164 in FIG. 4 and block 184 in FIG. 5. For example, the show effect may include projection of virtual imagery of flames encapsulating the appearance of the guest, and the virtual imagery may be deflected off a mirror and through the beam splitter for viewing by the guest. In another example, the virtual image may be balloons perceived as appearing from behind the guest. By triggering the show effect at the threshold distance, the virtual image may have a similar (or substantially similar) apparent depth in comparison to the reflected imagery of the guest. As such, the show effect may have a realistic appearance with respect to the reflected imagery.

If the position of the guest is not within the threshold distance, then the controller may not generate the show effect and the method or process may return to block 232 to receive sensor data indicative of the guest. This may avoid presentation of imagery that will not properly fit together due to the viewpoint of the guest being outside of the desired range for viewing. Avoiding operation outside of certain thresholds may prevent guests from observing incongruence in operation that can break immersion.

While only certain features of the disclosure have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112 (f). However, for any claims containing elements designated in any other manner, it is intended that such elements are not to be interpreted under 35 U.S.C. 112 (f).

1. A show effect system of an amusement park, the show effect system comprising:
a display configured to project one or more virtual images;
a mirror configured to deflect the one or more virtual images;
one or more sensors configured to transmit guest data based on guest detection in a viewing area, wherein the guest data comprises location and/or orientation data indicative of a guest relative to the mirror;
one or more actuators coupled with and configured to adjust positioning of the display and/or the mirror;
a beam splitter positioned between the viewing area and the mirror, wherein the beam splitter is configured to:
reflect light from the viewing area as reflected imagery back to the viewing area; and
enable transmission of the one or more virtual images deflected off the mirror through the beam splitter to the viewing area as transmitted imagery; and
one or more controllers communicatively coupled to the one or more sensors, and to at least the one or more actuators or the display, wherein the one or more controllers is configured to instruct the one or more actuators to adjust a position and/or an orientation of the display, the mirror, or both, based on the guest data.

2. The show effect system of claim 1, wherein the guest data comprises guest height data, and wherein the one or more controllers is configured to instruct the one or more actuators to adjust the position and/or the orientation of the display, the mirror, or both based on the guest height data.

3. The show effect system of claim 2, wherein the one or more controllers is configured to estimate a guest perspective based on the guest height data.

4. The show effect system of claim 3, wherein the one or more controllers is configured to instruct the one or more actuators to adjust the position and/or the orientation of the display, the mirror, or both to superimpose the reflected imagery and the transmitted imagery on one another based the guest perspective.

5. The show effect system of claim 1, wherein the one or more controllers is configured to:
generate image data based on the guest data;
transmit the image data to the display; and
instruct the display to project the one or more virtual images based on the image data.

6. The show effect system of claim 1, comprising one or more tracks movably coupled to the mirror and/or the display, wherein the one or more controllers is configured to instruct the one or more actuators to adjust the position and/or the orientation of the display, the mirror, or both along the one or more tracks.

7. The show effect system of claim 1, comprising an additional actuator coupled to the beam splitter and communicatively coupled to the one or more controllers, wherein the one or more controllers is configured to instruct the one or more actuators to adjust a position and/or an orientation of the beam splitter based on the guest data.

8. The show effect system of claim 1, comprising one or more physical objects positioned along with the display and the mirror on a side of the beam splitter opposite the viewing area.

9. The show effect system of claim 8, comprising a light source communicatively coupled to the one or more controllers, wherein the one or more controllers is configured to instruct modulating the light source to adjust visibility from the viewing area of the one or more physical objects through the beam splitter.

10. The show effect system of claim 1, wherein the display comprises a two-dimensional display, a three-dimensional display, or a volumetric display.

11. The show effect system of claim 1, wherein the beam splitter comprises a visual barrier.

12. A non-transitory computer-readable medium, comprising instructions that, when executed by one or more processors, are configured to cause the one or more processors to perform operations comprising:
determining a position and/or an orientation of a guest relative to a show effect system of an amusement park attraction system, wherein the show effect system comprises a beam splitter configured to reflect imagery of the guest as a reflected element at a first location, and the show effect system comprises a mirror and a display configured to project one or more virtual images onto the mirror for deflection through the beam splitter as a transmitted element at a second location; and
instructing one or more actuators of the show effect system to move and/or rotate the display, the mirror, or both to adjust projection of the one or more virtual images onto the mirror and to adjust the second location of the transmitted element based on the position and/or the orientation of the guest.

13. The non-transitory computer-readable medium of claim 12, wherein the instructions, when executed by the one or more processors, are configured to cause the one or more processors to perform operations comprising:
determining movement and/or orientation change of the guest to an additional position and/or orientation within the show effect system resulting in adjustment of the first location and/or orientation of the reflected element; and
instructing the one or more actuators to move and/or rotate the display, the mirror, or both to adjust the projection of the one or more virtual images onto the mirror and to adjust the second location and/or change the orientation of the transmitted element based on the movement and/or the orientation change of the guest to the additional position and/or orientation.

14. The non-transitory computer-readable medium of claim 13, wherein the instructions, when executed by the one or more processors, are configured to cause the one or more processors to perform operations comprising:
instructing the one or more actuators to move and/or rotate the display and the mirror toward one another in response to determining the movement and/or the orientation change of the guest is towards the beam splitter to the additional position and/or orientation; or
instructing the one or more actuators to move and/or rotate the display and the mirror away from one another in response to determining the movement and/or the orientation change of the guest is away from the beam splitter to the additional position and/or orientation.

15. The non-transitory computer-readable medium of claim 12, wherein the instructions, when executed by the one or more processors, are configured to cause the one or more processors to perform operations comprising:
determining a height of the guest; and
instructing the one or more actuators to move and/or rotate the mirror and/or the display based on the height of the guest.

16. The non-transitory computer-readable medium of claim 12, wherein the instructions, when executed by the one or more processors, are configured to:
instruct an additional actuator to adjust a position and/or an orientation of an object based on the position and/or the orientation of the guest.

17. The non-transitory computer-readable medium of claim 12, wherein the instructions, when executed by the one or more processors, are configured to cause the one or more processors to perform operations comprising:
determining a distance between the guest and the beam splitter;
determining the distance is within a threshold distance; and
instructing the display to project the one or more virtual images onto the mirror for deflection through the beam splitter as the transmitted element at the second location in response to determining the distance between the guest and the beam splitter is within the threshold distance.

18. An attraction system for an amusement park, the attraction system comprising:
a viewing area for a guest,
a beam splitter configured to reflect an appearance of the guest toward the viewing area;
a mirror positioned on an opposite side of the beam splitter from the viewing area;
a display configured to project one or more virtual images onto the mirror such that the mirror deflects the one or more virtual images through the beam splitter; and
one or more actuators configured to move the mirror and/or the display to adjust an apparent depth of the one or more virtual images.

19. The attraction system of claim 18, comprising:
one or more sensors configured to detect a position of the guest within the viewing area and generate position data based on the positioning; and
one or more controllers communicatively coupled to the one or more actuators, wherein the one or more controllers is configured to instruct the one or more actuators to move the display, the mirror, or both to adjust the apparent depth based on the position data.

20. The attraction system of claim 18, comprising one or more controllers coupled to the one or more actuators, wherein the one or more controllers are configured to perform operations comprising:
determining a first distance between the guest and the beam splitter; and
instructing the one or more actuators to adjust a second distance between the display and the mirror based on the first distance.
